(19) United States
(12) Patent Application Publication
(10) Pub. No.: US 2012/0330637 A1
(43) Pub. Date: Dec. 27, 2012

(54) METHOD FOR PROVIDING DEBUGGING TOOL FOR A HARDWARE DESIGN AND DEBUGGING TOOL FOR A HARDWARE DESIGN

(75) Inventors: Udo KRAUTZ, Stuttgart (DE); Stefan LETZ, Boeblingen (DE)

(73) Assignee: INTERNATIONAL BUSINESS MACHINES CORPORATION, Armonk, NY (US)

(21) Appl. No.: 13/523,983

(22) Filed: Jun. 15, 2012

(30) Foreign Application Priority Data
Jun. 21, 2011 (EP) 11170646.1

(51) Int. Cl. G06F 17/50

(52) U.S. Cl. 703/14

(57) ABSTRACT

A method is provided for providing a debugging tool for a hardware design specified in a hardware description language. The method includes receiving one or multiple source files of the specified hardware design; processing each source file in a way that hardware description language constructs from the hardware design are directly simulatable; wherein the processing process includes at least one of the following: restructuring procedural source code of the source file; preserving functional equivalence to unaltered source code of the source file; and adding debug information to the hardware description of said source file.

### PRIOR FOREIGN APPLICATION

This application claims priority from European patent application number 11170646.1, filed Jun. 21, 2011, which is hereby incorporated herein by reference in its entirety.

### TECHNICAL FIELD

The present invention relates in general to the field of hardware design processes, and in particular to a method for providing a debugging tool for hardware design and a debugging tool for hardware design. Still more particularly, the present invention relates to a data processing program and a computer program product for providing a debugging tool for a hardware design.

### BACKGROUND

The need for a more efficient hardware design process due to increased design complexity and improved capabilities in synthesis will lead to an increased use of procedural Very High Speed Integrated Circuit Hardware Description Language (VHDL) coding for high-performance designs. Using a more procedural VHDL coding style has already proven to increase efficiency in Application-Specific Integrated Circuit (ASIC) design and a similar development is expected in processor design.

Procedural VHDL is already used heavily in reference model implementations for formal verification. There, the procedural coding style allows expressing complex algorithms in a concise and flexible manner.

However, at this time, only insufficient support for debugging procedural VHDL is available. Procedural designs are usually debugged by using a waveform viewer to display the behavior of individual signals over time. However, such a waveform viewer cannot display the behavior of functions or variables since several assignments can be made to the same variable in one time step, for example. Furthermore, waveform viewers do not allow any form of path analysis within procedural code, making it very hard to actually understand how the code behaves.

Another possibility for debugging procedural VHDL is to manually add debug signals and to then use a waveform viewer. To make intermediate results visible and to understand the behavior of a piece of procedural code, it is possible to manually add additional variables and signals. It is then possible to view these intermediate results with a waveform viewer. However, this involves a lot of work and is error prone.

In the Patent Publication U.S. Pat. No.6,132,109 “ARCHITECTURE AND METHODS FOR A HARDWARE DESCRIPTION LANGUAGE SOURCE LEVEL DEBUGGING SYSTEM” by Gregory et al., a method for displaying circuit analysis results corresponding to parts of the circuit near the portion of the hardware description language (HDL) specification that generated that part of the circuit is disclosed. Further, a method for using probe statements in the HDL specification to mark additional points in the initial circuit that should not be eliminated during optimization is disclosed. This should improve the ability to display circuit analysis results near the appropriate part of the HDL specification.

In the Patent Publication U.S. Pat. No. 6,978,231 B2 “EMBEDDED HARDWARE DESCRIPTION LANGUAGE INSTRUMENTATION” by Williams et al., a method and program product for instrumenting an HDL design entity is disclosed. The design entity is created utilizing a HDL source code file within the syntax convention of a platform HDL. In accordance with the disclosed method, an instrumentation entity is described within the HDL source code file utilizing a non-conventional-syntax comment such that the instrumentation entity is embedded within the design entity without being incorporated into an overall design in which the design entity is incorporated. In accordance with a second embodiment, the HDL source code file includes a description of at least one operating event within the conventional syntax of the platform HDL. The disclosed method further includes associating the instrumentation entity with the operating event utilizing a non-conventional-syntax comment within the HDL source code file.

### BRIEF SUMMARY

In accordance with an aspect of the present invention, a method is provided for providing a debugging tool for a hardware design specified in a hardware description language. The method includes: receiving one or multiple source files of the specified hardware design; processing each source file in a way that hardware description language constructs from the hardware design are directly simulatable; wherein the processing process includes at least one of the following: restructuring procedural source code of the source file; preserving functional equivalence to unaltered source code of the source file; and adding debug information to the hardware description of the source file.

In another aspect, a debugging tool is provided for a hardware design specified in a hardware description language receiving one or more source files of the specified hardware design. The debugging tool includes a processing component for processing each source file in a way that hardware description language constructs from the hardware design are directly simulatable by a simulator component. The processor component performs at least one of the following: restructuring procedural source code of the source file; preserving functional equivalence of unaltered source code of the source file; and adding debug information to the hardware description of the source file.

In a further aspect, a computer program product is provided for providing a debugging tool for a hardware design specified in a hardware description language. The computer program product includes a computer-readable storage medium readable by a processor and storing instructions for execution by the processor for performing a method comprising: receiving one or multiple source files of the specified hardware design; processing each source file in a way that hardware description language constructs from the hardware design are directly simulatable; wherein the processing process includes at least one of the following: restructuring procedural source code of the source file; preserving functional equivalence to unaltered source code of the source file; and adding debug information to the hardware description of the source file.

### BRIEF DESCRIPTION OF THE SEVERAL VIEWS OF THE DRAWINGS

Embodiments of the present invention, as described in detail below, are shown in the drawings, in which:

FIG. 1 is a schematic block diagram of a development environment comprising a debugging tool for a hardware design, in accordance with an embodiment of the present invention;

FIG. 2 is a schematic flow diagram of a method for providing a debugging tool for a hardware design, in accordance with an embodiment of the present invention;

FIG. 3 is a schematic flow diagram of the processing process of VHDL source files as part of the method for providing a debugging tool for a hardware design of FIG. 2, in accordance with an embodiment of the present invention;

FIG. 4 is a schematic flow diagram of a loop-support process as part of the processing process of VHDL source files of FIG. 3, in accordance with an embodiment of the present invention;

FIG. 5 is a schematic flow diagram of function-support process as part of the processing process of VHDL source files of FIG. 3, in accordance with an embodiment of the present invention;

FIG. 6 is a schematic flow diagram of a path-analysis process as part of the processing process of VHDL source files of FIG. 3, in accordance with an embodiment of the present invention; and

FIG. 7 is a schematic flow diagram of an assignment-analysis process as part of the processing process of VHDL source files of FIG. 3, in accordance with an embodiment of the present invention.

### DETAILED DESCRIPTION

A technical problem underlying the present invention is to provide a method for providing a debugging tool for a hardware design and a debugging tool for a hardware design, which are able to directly relate language constructs of a hardware design language (HDL) in the design with simulated output of the HDL compiler, to allow a step-by-step debugging of the language constructs, and to solve the above-mentioned shortcomings and pain points of prior-art debugging tools for a hardware design.

According to the present invention, this problem is solved by providing a method for providing a debugging tool for a hardware design having the features of claim 1, a debugging tool for a hardware design having the features of claim 12, a data processing program for providing a debugging tool for a hardware design having the features of claim 14, and a computer program product for providing a debugging tool for a hardware design having the features of claim 15. Advantageous embodiments of the present invention are mentioned herein.

Accordingly, in an embodiment of the present invention, a method for providing a debugging tool for a hardware design specified in an HDL comprises: Receiving one or multiple source files of the specified hardware design; processing each source file in a way that HDL constructs from the hardware design are directly simulatable; wherein the processing process comprises at least one of the following: Restructuring procedural source code of the source file; preserving functional equivalence to unaltered source code of the source file; and adding debug information to the hardware description of the source file.

In further embodiments of the present invention, the processing process of the source file is implemented as a preprocessing process before performing a compiling process of the source file or implemented directly into an enhanced compiling process.

In further embodiments of the present invention, the debug information is added directly to a result of a compiling process and/or to a source code before and/or during the compiling process.

In further embodiments of the present invention, the debug information is added by creating an additional result during a compiling process, the additional result then being used in conjunction with the result of the unaltered source code for running a simulation process and/or a debugging process.

In further embodiments of the present invention, at least one of the following is performed during the processing process of the source file: Loop support, function support, path analysis, assignment analysis, and input-and-output analysis.

In further embodiments of the present invention, during the loop-support process, existing loops are unrolled for their respective number of iterations, which is determined during a compiling process.

In further embodiments of the present invention, during the function-support process in case of outside process use of the function, the existing function is converted to an instantiated entity by coping a body of the function to a newly created entity, wherein inputs of the new entity are parameters of the function, and the output of the new entity is the result of the function; and in case of inside process use of the function, a body of the function is copied to the process and intermediate variables of the function are transformed to local variables of the process.

In further embodiments of the present invention, during the path-analysis process, branch identifiers are added as debug signals for if-then-else and case-choice constructs.

In further embodiments of the present invention, during the assignment-analysis process, debug variables holding intermediate values assigned to each source variable are introduced.

In further embodiments of the present invention, during the input-and-output-analysis process, each input signal of an entity is assigned to a corresponding intermediate signal and/or each output signal of the entity is assigned to a corresponding intermediate signal.

In further embodiments of the present invention, the debug information comprises correlation information related to unrolled loops and original source code lines; replaced function calls and original source code lines; branch identifiers and original source code lines; and debug variables and original source code lines.

In another embodiment of the present invention, a debugging tool for a hardware design specified in an HDL receives one or multiple source files of the specified hardware design; and comprises a processor component for processing each source file in a way that HDL constructs from the hardware design are directly simulatable by a simulator component; wherein the processor component performs at least one of the following: Restructuring procedural source code of the source file; preserving functional equivalence to unaltered source code of the source file; and adding debug information to the hardware description of the source file.

In further embodiments of the present invention, the debugging tool comprises a compiler component for compiling a processed source file, wherein debug information is added directly to a result of a compiling process and/or to a source code before and/or during the compiling process.

In another embodiment of the present invention, a data processing program for execution in a data processing system comprises software code portions for performing a method for providing a debugging tool for a hardware design when the program is run on the data processing system.

In yet another embodiment of the present invention, a computer program product stored on a computer-usable medium comprises computer-readable program means for causing a computer to perform a method for providing a debugging tool for a hardware design when the program is run on the computer.

Embodiments of the present invention address the transformation of a hardware design which is specified in a HDL into a simulatable form, wherein debugging hardware descriptions are added such that HDL constructs from the design can be directly simulated with the debugging hardware descriptions.

An idea of the present invention is to propose an automatic pre-process -potentially integrated into an enhanced compilation process - that automatically restructures procedural code to support debugging efforts while at the same time preserving functional equivalence to the unaltered code. The compiled result is enriched with debug information, which the user can easily analyze in a standard waveform viewer or in an enhanced development environment.

Embodiments of the present invention employ five steps comprising loop support, function support, path analysis, assignment analysis, and input-and-output analysis that can be used separately or simultaneously, as needed for VHDL/Verilog processes and entities.

These steps are implemented either as a pre-process, which is executed prior to compilation of the HDL, or as a part of the compilation process, i.e., as a part of the HDL compiler.

Any information that is added during this process will be recorded in a database. This database allows to correlate any changes made to the original code and can be used to present the debug information more concisely in an enhanced development environment.

To enrich the HDL two options are proposed: First, the debug information is added directly to the HDL compilation result or the source before/during compilation. Second, an additional compilation result is created during compilation that can be used in conjunction with the result of the unaltered source for running simulation and/or debugging.

Loops are hard to debug as, for example, assignments and function calls are executed multiple times during a single simulated time step. Hence, these are not observable in a waveform viewer. Thus, during the loop-support process existing loops are unrolled for their respective number of iterations, which can be determined at compilation time.

Functions are hard to debug due to synthesis optimizations done by the compiler. Their private variables are not observable and the compilation process makes them unavailable for path-analysis processes. Thus, during the function-support process, a restructuring of function calls in the HDL is performed either by the compiler or by the pre-process.

If functions are used outside of processes, the functions are converted to instantiated entities by coping the function's body to a newly created entity. Inputs to the new entity are the parameters of the function and the output is the function's result. The new entity will not just instantiate the previous function but will contain its body and if required intermediate signals/variables.

By instantiating an entity instead of a function call, the pre-process or the compiler creates a structure that is observable for analysis. The substitution of a function requires parsing of the HDL code because of function overloading.

If functions are called inside of processes, the function body is copied to the process and intermediate variables of the function are converted into local variables of the process. Thereby, the intermediate variables become observable and debugging becomes easier.

To analyze a procedural piece of code and enable static code inspection, during path analysis debug signals are added for if-then-else and case-choice constructs, since these are relevant for such an analysis. Embodiments of the invention introduce branch identifiers named according to the line of each branch, thereby enabling the user to exactly see which branch was taken simply by evaluating whether the branch identifier is ‘1’ for true (taken) or ‘0’ for false (not taken). A vector variable could also be used as branch identifier.

Since variables can be assigned at several places within procedural code, it is difficult to determine the final assignment. Furthermore, it is not possible to view intermediate assignments. Therefore, during assignment analyses, embodiments of the present invention introduce temporary debug variables that hold intermediate values assigned to each source variable. By introducing unique debug variables with names derived from the original variable, the user is enabled to exactly follow multiple assignments to a variable.

Alternatively, “a_xxx:= . . . ” statements could be placed in front of the respective assignments, thus capturing the old value of variable “a” instead of the new value.

Optionally, “a_xxx_v:=1” statements could be inserted along with the “a_xxx” statements to clearly identify which assignments were actually evaluated. However, this is not required when the path-analysis process is enabled along with the assignment-analysis rocess.

Considering an entity having an output signal, the user cannot see this output signal in the waveform viewer because the compiler optimizes it away for synthesis. Thus, embodiments of the present invention add intermediate signals to make these port assignments visible again.

Considering an entity having an input signal, similarly, the user cannot see this signal in the waveform viewer. Assigning the input signal to an intermediate signal makes it visible.

The above, as well as additional purposes, features, and advantages of the present invention will become apparent in the following description.

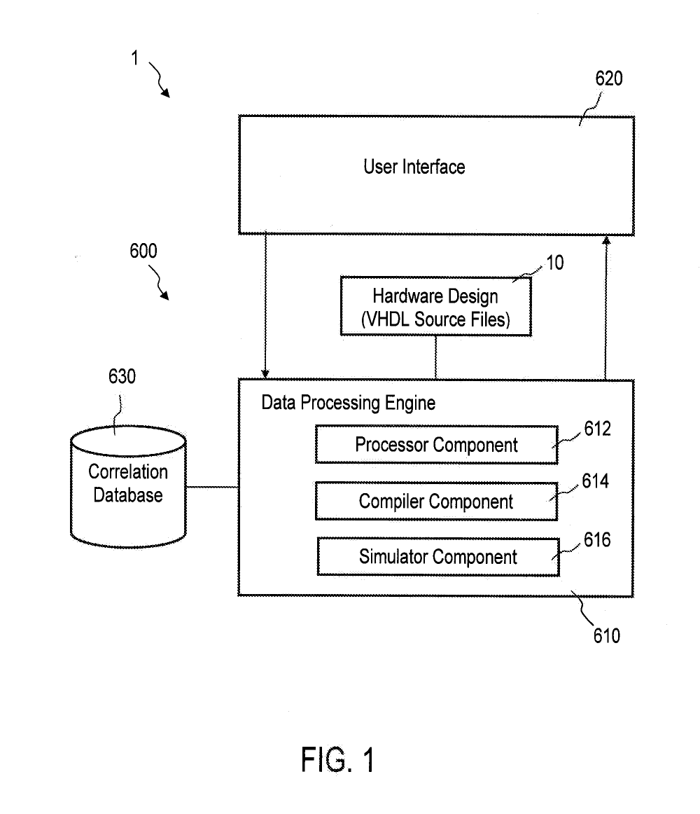

FIG. 1 is a schematic block diagram of a development environment 1 comprising a debugging tool 600 for a hardware design, in accordance with an embodiment of the present invention.

Referring to FIG. 1, the shown embodiment of the present invention employs a debugging tool 600 for a hardware design specified in a hardware description language (HDL) receiving one or multiple source files 10 of the specified hardware design. According to the present invention, the debugging tool 600 comprises a processor component 612 for processing each source file 10 in a way that HDL constructs from the hardware design are directly simulatable by a simulator component 616. The processor component 612 performs at least one of the following steps: Restructuring procedural source code of the source file 10; preserving functional equivalence to unaltered source code of the source file 10; and adding debug information to the hardware description of the source file 10. Further, the debugging tool 600 comprises a compiler component 614 for compiling a processed source file, wherein debug information is added directly to a result of the compiling process and/or to a source code before and/or during the compiling process. Any information that is added during these processes will be recorded in a database 630 as correlation information. This database 630 allows to correlate any changes made to the original code and can be used to present the debug information more concisely in an enhanced development environment.

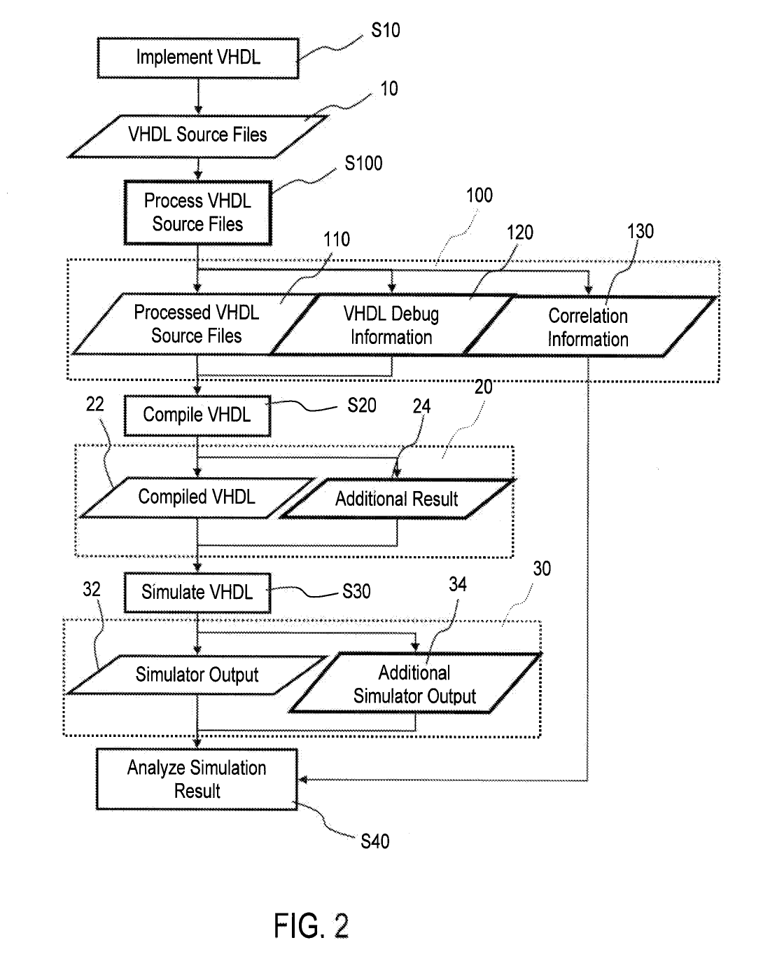

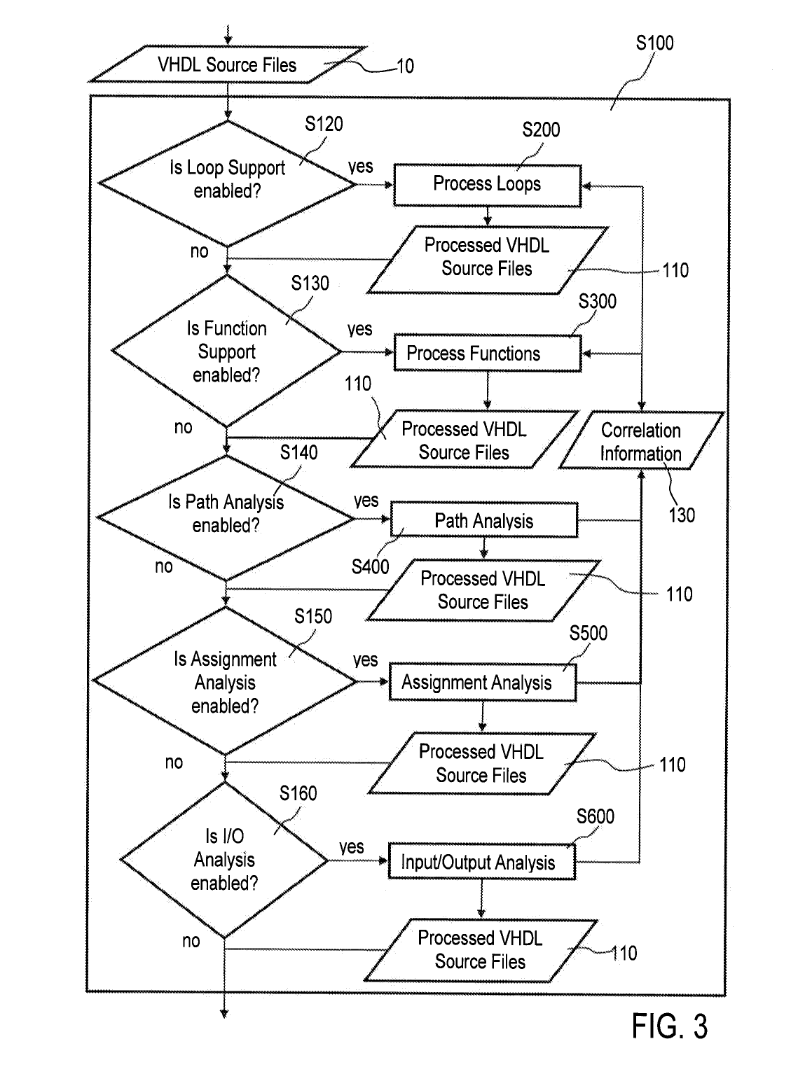

FIG. 2 is a schematic flow diagram of a method for providing a debugging tool 600 for a hardware design, in accordance with an embodiment of the present invention; and FIG. 3 is a schematic flow diagram of the processing process of VHDL source files 10 as part of the method for providing a debugging tool 600 for a hardware design of FIG. 2, in accordance with an embodiment of the present invention.

Referring to FIGS. 2 and 3, the shown embodiment of a method for providing a debugging tool 600 comprises in step S10 an implementation of the hardware design in VHDL (Very High Speed Integrated Circuit Hardware Description Language), for example, comprising in at least one VHDL source file 10. During process S100 at least one source file 10 of the specified hardware design is received and processed in a way that VHDL constructs from the hardware design are directly simulatable. The processing of at least one VHDL source file 10 in process S100 comprises at least one of the following: Restructuring procedural source code of the source file 10; preserving functional equivalence to unaltered source code of the source file 10; and adding debug information 120 to the hardware description of the source file 10. Any information 120 that is added during these processes will be recorded in the above mentioned database 630 as correlation information 130.

Referring to FIG. 2, a result 100 of the processing of the VHDL source file 10 during process S100 comprises at least one processed VHDL source file 110, VHDL debug information 120, and total correlation information 130. In the shown embodiment, the processing of the source file 10 is implemented as a preprocessing process S100 before performing a compiling process S20 of the source file 10. Alternatively, the processing process S100 of the source file 10 may be implemented directly into an enhanced compiling process, which is not shown.

In process S20, the result 100 of the processing of the VHDL source file 10 is compiled, creating a total compiler output 20. The VHDL debug information 120 is added directly to the result of the compiling process 20 and/or to a source code before and/or during said compiling process S20. The debug information 120 results in an additional result 24 during the compiling process S20, for example, wherein the additional result 24 is used in conjunction with the result of the unaltered source code 22 for running a simulation process S30 and/or a debugging process.

In process S30, the output 20 of the compiling process S20 is simulated, creating a total simulator output 30 comprising a simulator output 32 and an additional simulator output 34. The total simulator output 30 is analyzed in process S40 using correlation information 130, if available.

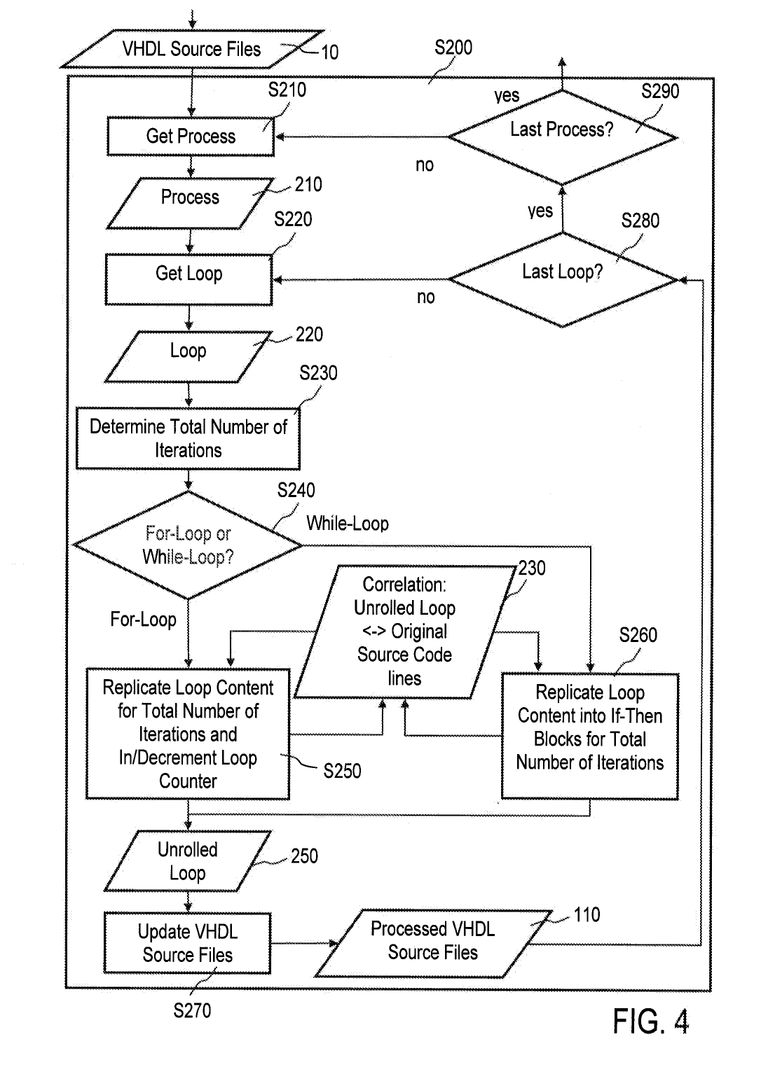

Referring to FIG. 3, during the processing of the VHDL source file 10 during process S100, in step S120 it is checked whether the loop-support process S200 is enabled or not. If the loop-support process S200 is enabled, the loops are processed during process S200 and the processed VHDL source file 110 is output as result of the loop-support process S200. A detailed description of the loop-support process S200 is given later in accordance with FIG. 4. Loops are hard to debug as for example assignments and function calls are executed multiple times. Existing loops are unrolled for their respective number of iterations, which can be determined at compile time.

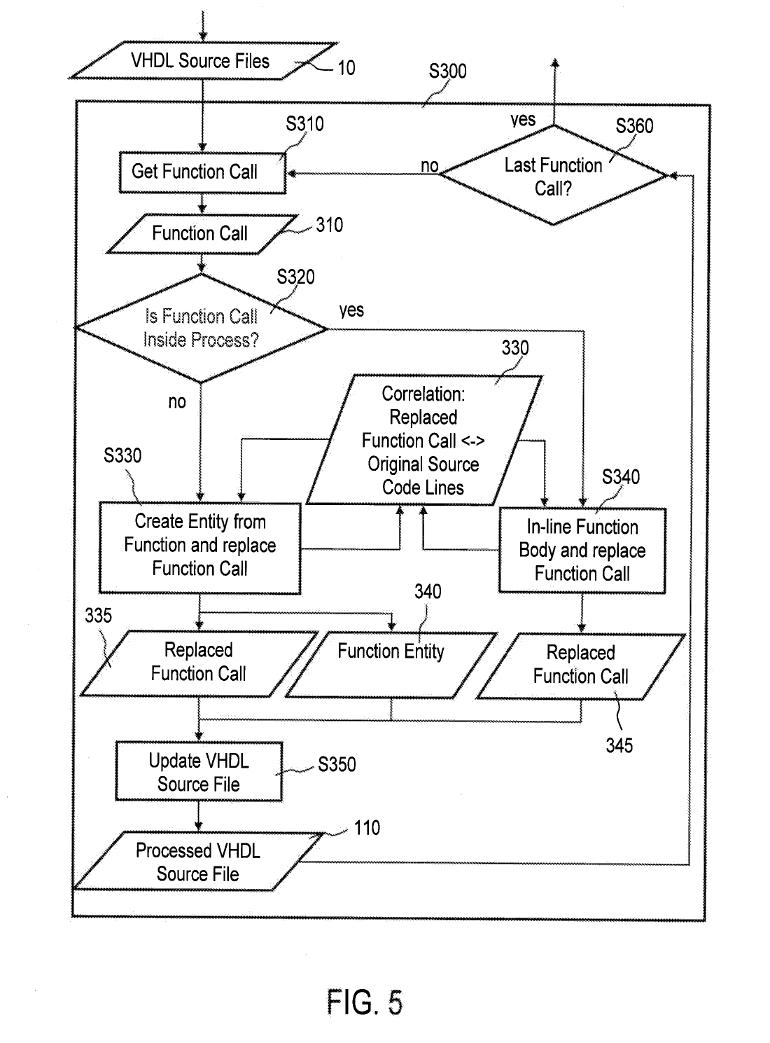

If the loop-support process S200 is finished or if the loop-support process S200 is not enabled, in step S130 it is checked whether the function-support process S300 is enabled or not. If the function-support process S300 is enabled, the functions are processed during process S300 and the processed VHDL source file 110 is output as result of the function-support process S300. A detailed description of the function-support process S300 is given later in accordance with FIG. 5. Functions are hard to debug due to synthesis optimizations done by the compiler. Private variables of the functions are not observable and the compiling process makes them unavailable for the path-analysis process S400. Thus, a restructuring of function calls is performed in the VHDL source files 10 either by the compiler or by a pre-process.

If functions are used outside of processes, the functions are converted to instantiated entities by copying a function body to a newly created entity. Inputs to the new entity are the parameters of the function and the output is the function result. The new entity will not just instantiate the previous function but will contain the body of the function and intermediate signals/variables, if required.

### EXAMPLE 1

| | |
|---|---|
| FUNCTION sum ( | a: std_ulogic_vector(0 to 1), |
| | b: std_ulogic_vector(0 to 1)) |
| | return sum std_ulogic_vector IS |

VARIABLE temp: std_ulogic_vector(0 to 1);
BEGIN

| | |
|---|---|
| temp | := a + b; |
| sum | := temp; |

END FUNCTION;
ENTITY sum
PORT{

| | |
|---|---|
| a | : IN std_ulogic_vector(0 to 1); |
| b | : IN std_ulogic_vector(0 to 1); |
| sum | : OUT std_ulogic_vector(0 to 1)} |

ARCHITECTURE sum OF sum IS
SIGNAL temp : std_ulogic_vector;
BEGIN

| | |
|---|---|
| Temp | <= a + b; |
| Sum | <= temp; |

END;

By instantiating an entity instead of a function call, the pre-process or the compiler creates a structure that is observable for analysis methods. The substitution of a function requires parsing of the VHDL code because of function overloading. Result vector widths are not specified in a function definition and have to match the calling code, for example.

If functions are called inside of processes, the function body is copied to the process and intermediate variables of the function are converted into local variables of the process. Thereby, the variables become observable and debugging becomes easier.

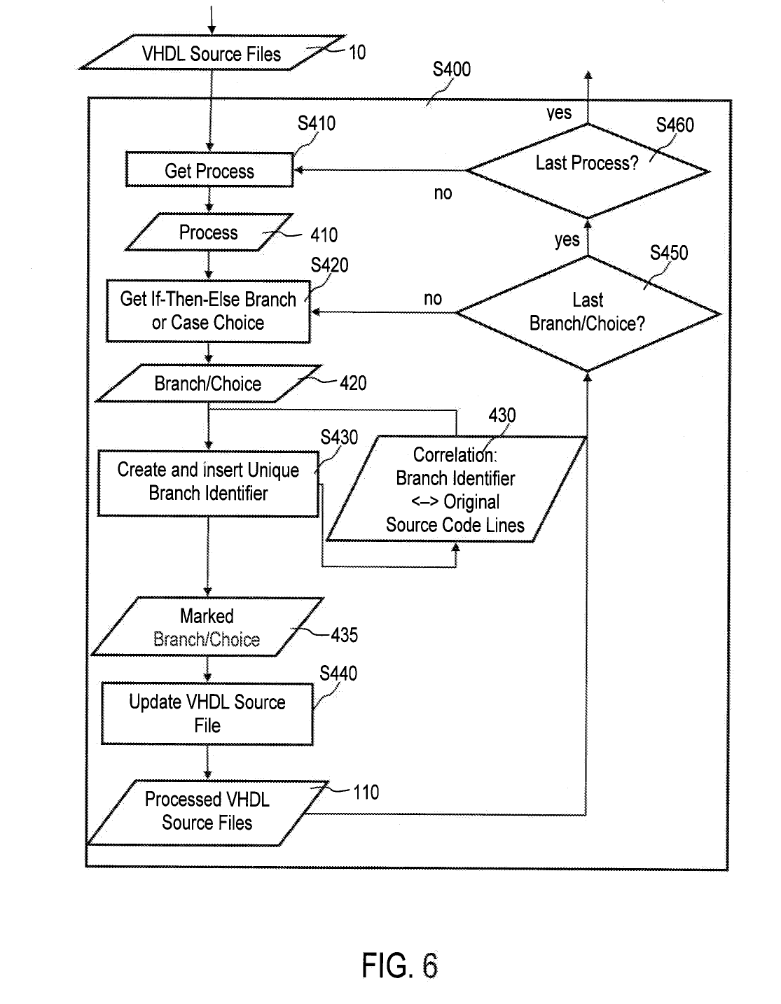

If the function-support process S300 is finished or if the function-support process S300 is not enabled, in step S140 it is checked whether the path analysis process S400 is enabled or not. If the path-analysis process S400 is enabled, the path analysis is performed during process S400 and the processed VHDL source file 110 is output as result of the path-analysis process S400. A detailed description of the path-analysis process S400 is given later in accordance with FIG. 6. To analyze a procedural piece of code and enable static code inspection, debug signals are added for if-then-else and case-choice constructs, since these are the relevant constructs for such an analysis. Branch identifiers are introduced as debug signals named according to the line of each branch, thereby enabling the user to exactly see which branch was taken simply by evaluating whether the branch identifier is ‘1’ for true (taken) or ‘0’ for false (not taken).

### EXAMPLE 2

| | line101:= ‘0’; (branch identifier) |
|---|---|
| | line103:= ‘0’; (branch identifier) |
| | ... |
| 101: | IF ... THEN |
| | line101:= ‘1’; |
| 102: | . . . |
| 103: | ELSE IF ... THEN |
| | line103:= ‘1’; |
| 104: | . . . |
| 105: | ELSE |
| 106: | . . . |
| 107: | END IF; |

Instead of branch identifier line 101, line 103, etc., a vector identifier could be used: linevec:=“00”, for example.

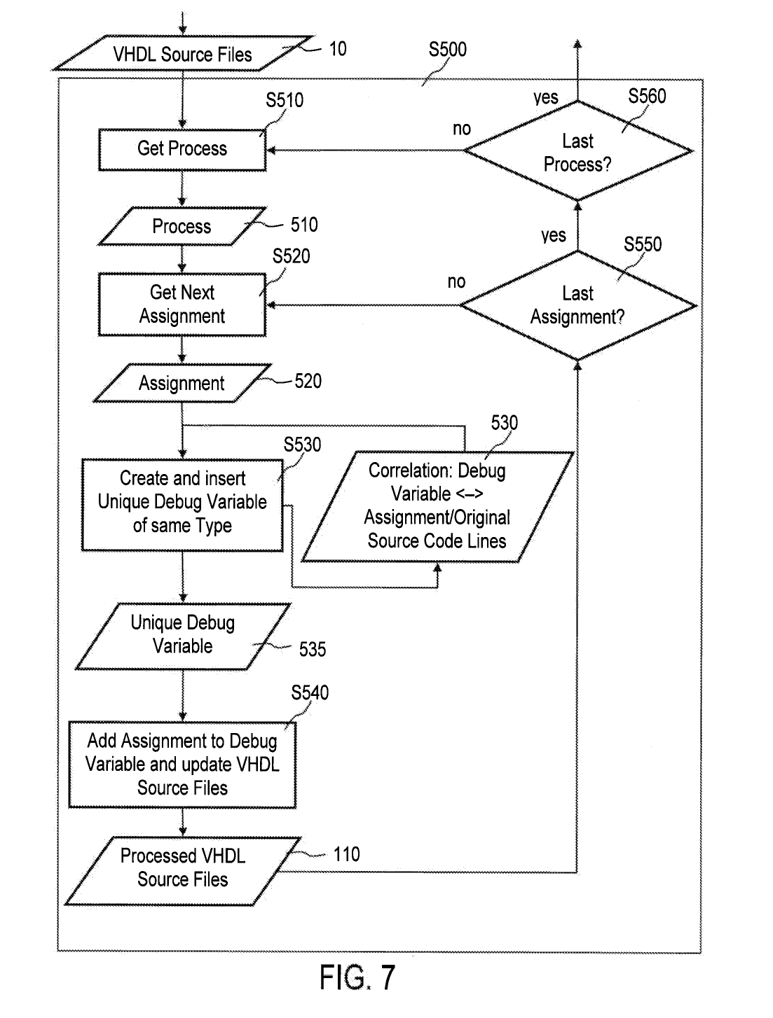

If the path analysis in process S400 is finished or if the path-analysis process S400 is not enabled, in step S150 it is checked whether the assignment-analysis process S500 is enabled or not. If the assignment-analysis process S500 is enabled, the assignment analysis is performed during process S500 and the processed VHDL source file 110 is output as result of the assignment-analysis process S500. A detailed description of the assignment-analysis process S500 is given later in accordance with FIG. 7. Since variables can be assigned at several places within procedural code, it is difficult to determine the final assignment. Furthermore, it is not possible to view intermediate assignments. Therefore, temporary debug variables are introduced that hold intermediate values assigned to each source variable. By introducing unique debug variables with names derived from the original variable, the user is enabled to exactly follow multiple assignments to a variable.

### EXAMPLE 3

| | a_002:= 0; (debug variable) |
|---|---|
| | a_004:= 0; (debug variable) |
| | ... |
| 101: | IF ... THEN |
| 102: | a := 1; |
| | a_002 := a; [a_002_v := 1;] |
| 103: | ELSE |
| 104: | a := 0; |
| | a_004 := a; [a_004_v := 1;] |
| 105: | END IF; |

Alternatively, the “a_x xx” statements could be placed in front of the respective assignments, thus capturing the old value of variable “a” instead of the new value.

Optionally, “a_xxx_v:=1” statements could be inserted along with the “a_x xx” statements to clearly identify which assignments were actually evaluated. However, this is not required when the path-analysis process is enabled along with the assignment-analysis process.

If the assignment analysis in process S500 is finished or if the assignment-analysis process S500 is not enabled, in step S160 it is checked whether the input/output-analysis process S600 is enabled or not. If the input/output-analysis process S600 is enabled, the input/output-analysis is performed during process S600 and the processed VHDL source file 110 is output as result of the input/output-analysis process S600. Considering an entity having an output signal result vec, the user cannot see this signal in the waveform viewer because the compiler eliminates it during optimization for synthesis. Thus, intermediate signals are added to make these port assignments visible again.

### EXAMPLE 4

result_vec<=int_result_vec and mask_vec;

### Option 1:

result_vec<=int_result_vec and mask_vec;

out_result_vec<=int_result_vec and mask_vec;

### Option 2:

result_vec<=out_result_vec;

out_result_vec<=int_result_vec and mask_vec;

Considering an entity having an input signal input_vec, the user cannot see this signal in the waveform viewer. Assigning the input signal to an intermediate signal makes it observable.

### EXAMPLE 5

### in_input_vec<=input_vec;

Any information that is added during these processes will be recorded in the database 630 as correlation information 130. This database 630 allows to correlate any changes made to the original code and can be used to present the debug information more concisely by an enhanced development environment.

FIG. 4 is a schematic flow diagram of the loop-support process S200 as part of the processing process S100 of VHDL source files of FIG. 3, in accordance with an embodiment of the present invention; FIG. 5 is a schematic flow diagram of the function-support process S300 as part of the processing process S100 of VHDL source files of FIG. 3, in accordance with an embodiment of the present invention; FIG. 6 is a schematic flow diagram of the path-analysis process S400 as part of the processing process S100 of VHDL source files of FIG. 3, in accordance with an embodiment of the present invention; and FIG. 7 is a schematic flow diagram of the assignment-analysis process S500 as part of the processing process S100 of VHDL source files of FIG. 3, in accordance with an embodiment of the present invention.

Referring to FIG. 4, during execution of the loop-support process S200, in step S210 the VHDL source file 10 is scanned for processes and a found process 210 is loaded. During step S220, the process 210 is scanned for loops and a corresponding loop 220 is loaded. In step S230, a total number of iterations of the loop 220 is determined. In decision S240, it is checked whether the loop 220 is a for loop or a while loop. If the loop 220 is a for loop, in step S250 the content of loop 220 is replicated for the total number of iterations and a loop counter is incremented or decremented. If the loop 220 is a while loop, in step S260 the content of loop 220 is replicated into if-then blocks for the total number of iterations. The output of steps S250 or S260 is an unrolled loop 250. Further, first correlation information 230 is output based on the correlation of the unrolled loop 250 and the original source code lines. In step S270, the VHDL source file 10 is updated and a processed VHDL source file 110 is output. In decision S280, it is checked whether the current loop is the last loop of the corresponding process. If not, the process S200 is continued with step S220 and the next loop is loaded. If the current loop is the last loop of the corresponding process, the process S200 is continued with decision S290. In decision S290, it is checked whether the current process is the last process of the corresponding VHDL source file 10. If not, the process S200 is continued with step S210 and the next process is loaded. If the current process is the last process of the corresponding VHDL source file 10, the loop-support process S200 is finished.

Referring to FIG. 5, during execution of the function-support process S300, in step S310 the VHDL source file 10 or the processed VHDL source file 110 output by the loop-support process S200 is scanned for function calls and a found function call 310 is loaded. In decision S320, it is checked whether the function call 310 is inside a process or not. If the function call 310 is not inside a process, a new entity is created and the function call 310 is replaced in step S330. Output data of step S330 comprises a replaced function call 335 and the new function entity 340. If the function call 310 is inside a process, the corresponding function body is in-lined and the function call 310 is replaced in step S340. This means that the corresponding function body is copied to the process and intermediate variables of the function are converted into local variables of the process. Output data of step S340 comprises a replaced function call 345. Further, second correlation information 330 is output based on the correlation of the replaced function calls 335 or 345 and the original source code lines. In step S350, the VHDL source file 10 or the processed source file 110 output by the loop processing S200 is updated and a processed VHDL source file 110 is output. In decision S360, it is checked whether the actually processed function call is the last function call of the corresponding source file. If not, the process S300 is continued with step S310 and the next function call is loaded. If the current function call is the last function call of the corresponding source file, the function-support process S300 is finished.

Referring to FIG. 6, during execution of the path-analysis process S400, in step S410 the VHDL source file 10 or the processed VHDL source file 110 output by the loop-support process S200 or the function-support process S300 is scanned for processes and a found process 410 is loaded. During step S420, the process 410 is scanned for if-then-else branches or case choices, and a corresponding branch/choice 420 is loaded. In step S430, a unique branch identifier is created and inserted. Output data of step S430 comprises a marked branch/choice 435. Further, third correlation information 430 is output based on the correlation of the branch identifier and the original source code lines. In step S440, the VHDL source file 10 or the processed source file 110 output by the loop-support process S200 or the function-support process S300 is updated and a processed VHDL source file 110 is output. In decision S450, it is checked whether the current branch/choice is the last branch/choice of the corresponding source file. If not, the process S400 is continued with step S420 and the next if-then-else branch or case choice 420 is loaded. If the current branch/choice is the last branch/choice of the corresponding process, the process S400 is continued with decision S460. In decision S460, it is checked whether the current process is the last process of the corresponding source file. If not, the process S400 is continued with step S410 and the next process is loaded. If the current process is the last process of the corresponding source file, the path analysis process S400 is finished.

Referring to FIG. 7, during execution of the assignment-analysis process S500, in step S510 the VHDL source file 10 or the processed VHDL source file 110 output by the loop-support process S200 or the function-support process S300 or the path-analysis process S400 is scanned for processes and a found process S10 is loaded. During step S520, the process S10 is scanned for assignments and a corresponding assignment 520 is loaded. In step S530, a unique debug variable 535 is created and inserted. Output data of step S530 comprises the unique debug variable 535. Further, fourth correlation information 530 is output based on the correlation of the debug variable 535 and the assignment and/or original source code lines. In step S540, the assignment is added to the debug variable 535 and the VHDL source file 10 or the processed source file 110 output by the loop-support process S200 or the function-support process S300 or the path-analysis process S400 is updated and a processed VHDL source file 110 is output. In decision S550, it is checked whether the current assignment is the last assignment of the corresponding source file. If not, the process S500 is continued with step S520 and the next assignment 520 is loaded. If the current assignment is the last assignment of the corresponding process, the process S500 is continued with decision S560. In decision S560, it is checked whether the current process is the last process of the corresponding source file. If not, the process S500 is continued with step S510 and the next process S10 is loaded. If the current process is the last process of the corresponding source file, the assignment-analysis process S500 is finished.

The inventive method for providing a debugging tool for a hardware design can be implemented as an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include Compact Disc-read only memory (CD-ROM), Compact Disc-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for providing a debugging tool for a hardware design specified in a hardware description language, the method comprising:
receiving one or multiple source files of said specified hardware design;
processing each source file in a way that hardware description language constructs from said hardware design are directly simulatable;
wherein said processing process comprises at least one of the following:
restructuring procedural source code of said source file;
preserving functional equivalence to unaltered source code of said source file; and
adding debug information to said hardware description of said source file.

2. The method according to claim 1, wherein said processing process of said source file is implemented as a preprocessing process before performing a compiling process of said source file or implemented directly into an enhanced compiling process.

3. The method according to claim 1, wherein said debug information is added directly to a result of a compiling process and/or to a source code before and/or during said compiling process.

4. The method according to claim 1, wherein said debug information is added by creating an additional result during a compiling process, said additional result then being used in conjunction with said result of said unaltered source code for running a simulation process and/or a debugging process.

5. The method according to claim 1, wherein at least one of the following is performed during said processing process of said source file: loop support, function support, path analysis, assignment analysis, and input-and-output analysis.

6. The method according to claim 5, wherein during said loop-support process, existing loops are unrolled for their respective number of iterations, which is determined during said compiling process.

7. The method according to claim 5, wherein during said function-support process in case of outside process use of said function, said existing function is converted to an instantiated entity by copying a body of said function to a newly created entity, wherein inputs of said new entity are parameters of said function, and the output of said new entity is the result of said function; and in case of inside process use of said function, a body of said function is copied to said process and intermediate variables of said function are transformed to local variables of said process.

8. The method according to claim 5, wherein during said path-analysis process, branch identifiers are added as debug signals for if-then-else and case-choice constructs.

9. The method according to claim 5, wherein during said assignment-analysis process, debug variables holding intermediate values assigned to each source variable are introduced.

10. The method according to claim 5, wherein during said input-and-output-analysis process, each input signal of an entity is assigned to a corresponding intermediate signal and/or each output signal of said entity is assigned to a corresponding intermediate signal.

11. The method according to claim 5, wherein said debug information comprises correlation information related to: unrolled loops and original source code lines; replaced function calls and original source code lines; branch identifiers and original source code lines; and debug variables and original source code lines.

12. A debugging tool for a hardware design specified in a hardware description language receiving one or multiple source files of said specified hardware design, said debugging tool comprising:
a processor component for processing each source file in a way that hardware description language constructs from said hardware design are directly simulatable by a simulator component;
wherein said processor component performs at least one of the following:
restructuring procedural source code of said source file;
preserving functional equivalence to unaltered source code of said source file; and
adding debug information to said hardware description of said source file.

13. The debugging tool according to claim 12, further comprising a compiler component for compiling a processed source file, wherein debug information is added directly to a result of said compiling process and/or to a source code before and/or during said compiling process.

14. A computer program product for debugging a hardware design specified in a hardware description language, the computer program product comprising:
a computer-readable storage medium readable by a processor and storing instructions for execution by the processor for performing a method comprising:
receiving one or multiple source files of said specified hardware design;
processing each source file in a way that hardware description language constructs from said hardware design are directly simulatable;
wherein the processing process comprises at least one of the following:
restructuring procedural source code of the source file;
preserving functional equivalence to unaltered source code of the source file; and
adding debug information to said hardware description of the source file.
